(19) United States
(12) Patent Application Publication
(10) Pub. No.: US 2004/0002339 A1
(43) Pub. Date: Jan. 1, 2004

(54) Method and apparatus for allocating bandwidth resources

(75) Inventor: Neil O'Connor, Lackagh (IE)

Correspondence Address: William M. Lee, Jr., Lee, Mann, Smith,, McWilliams, Sweeney & Ohlson, P.O. Box 2786, Chicago, IL, 60690-2786, US

(73) Assignee: Nortel Networks Limited

(21) Appl. No.: 10/185,114

(22) Filed: Jun. 28, 2002

(51) Int. Cl. H04Q 7/20

(52) U.S. Cl. 455/450; 455/513

(57) ABSTRACT

A method of allocating bandwidth resources in a telecommunications network to which a plurality of devices are connected, involves the steps of: a) receiving from a first of the devices engaged in a call a suspend signal indicative that outgoing traffic from that device has been temporarily suspended, while the device remains engaged in the call; and b) upon receipt of the signal, allocating additional bandwidth to one or more other of the devices. The allocation of bandwidth can be carried out by one of the devices engaged in a call, or by a network bandwidth allocation device which oversees the bandwidth allocation used by each calling device and adjusts allocations dynamically as devices suspend and recommence their outgoing traffic. The adjustment of bandwidth allocation is preferably achieved by the device(s) switching codecs, and the suspend signals preferably result from the deactivation of transmissions in response to a voice activity detection unit in the first device.

### FIELD OF THE INVENTION

This invention relates to the allocation of bandwidth resources.

### BACKGROUND ART

Network capacity is defined in terms of bandwidth, and the amount of bandwidth available on a network determines the number of devices which can simultaneously use the network, and the amount of data which each device can send or receive.

In digital telecommunications networks, signals are encoded (and for packet-based networks, the encoded signals are packetised) before being transmitted over the network. The encoding algorithms typically used (and the corresponding decoding algorithms for converting the signals to audio, video or the like) are referred to as codecs. To preserve bandwidth, most codecs in common use both compress and encode the signal (or decode and decompress at the receiving end). Different codecs employ different methods of compression, and in general as a signal is more and more compressed, its quality becomes worse. This is perceived, in audio terms, as providing a less natural sound. Fidelity of sound is lost, and the frequencies transmitted are strictly limited.

Ideally, signals would be compressed as little as possible for near perfect audio reproduction, but in practice, bandwidth considerations force the network designer to employ compressive codecs. In specifying the capacity of a network, the designers will indicate the number of devices of a particular type which can be simultaneously supported and the codec that each device is to use. When these limits are exceeded, devices may not be able to gain access to the network or signals will be lost during transmission over the network.

An example of the type of network where this is an issue is a wireless private telephone network which comprises a basestation 10 and a number of handsets 12 in wireless communication with the basestation, as shown in FIG. 1. The basestation 10 may be connected to a private branch exchange or PBX 14 (which will have other telephone extensions 16 connected to it), which in turn is connected to the public switched telephone network or PSTN 18. Typical wireless networks of this type allow voice over Internet protocol (VoIP) communications with signals being transmitted via the 802.11 protocol. Nortel Networks supplies such a wireless solution under the trade mark “eMobility”. Each handset can communicate with each other handset with signals being relayed via the basestation. Furthermore, each handset can call other extensions of the private branch exchange with signals being transmitted to the basestation which in turn is connected to an Internet telephony gateway or ITG 20 which acts as a gatekeeper for the system. The ITG employs an IP stack to convert between the proprietary signals used in the PBX (which in this case is the Meridian I PBX from Nortel Networks) and the data packets required in the wireless network.

Bandwidth considerations impose the limitation that the maximum number of callers supported by each eMobility basestation is 8, and that the only codec supported is the G.729 codec (details of which are provided in the G.729 standards issued by the International Telecommunications Union).

As G.729 is a relatively high compression standard it provides worse speech quality than, for example, the G.711 standard. In its present design specification, however, the eMobility product does not support the use of G.711 since this would limit the number of callers even more.

Similar problems can be found in any other network where bandwidth is a limited resource, and the present invention has as an object the provision of improved methods of allocating bandwidth resources to devices on a network.

### SUMMARY OF THE INVENTION

The invention provides a method of allocating bandwidth resources in a telecommunications network to which a number of devices, such as telephone handsets, are connected. The steps of the method include:

a) receiving a suspend signal from one of the devices which is engaged in a call, with this suspend signal indicating that outgoing traffic from that device has been temporarily suspended, even though the device remains engaged in the call; and

b) on receiving this suspend signal, allocating additional bandwidth to one or more other of the devices on the network.

One of the advantages provided by this method is that it allows bandwidth to be allocated to devices based on the actual usage of network resources rather than limiting the bandwidth for a device because of the need to retain resources for other devices which are not actually using these resources at the time. In particular, whereas when a device is engaged in a call it conventionally been the normal practice to assign bandwidth to that device, the present invention allows bandwidth from that device to be assigned elsewhere when the device temporarily suspends transmissions during the call.

Taking the example of the eMobility basestation with 8 connected handsets, even when all of the handsets are engaged in voice calls to one another or to external terminations, about half of the devices will be silent on average at any one time. The invention allows the bandwidth allocations to be increased for the non-silent devices, giving them the opportunity to employ codecs which provide a higher voice quality than the codec theoretically allowed for the network with all devices engaged in calls.

Suitably, the first device can employ an audio volume threshold detection system to suspend outgoing traffic when the audio volume of signals for transmission drop below a threshold. The first device transmits the suspend signal when outgoing traffic is suspended in this way.

Such “audio volume threshold detection systems” are known for voice phones as voice activity detection (VAD) systems, and are well known in the art. The invention takes advantage of a VAD facility by transmitting a suspend signal when the VAD feature is activated (i.e. when the user stops talking and the microphone volume drops below a threshold, outgoing traffic is terminated and a signal to indicate this termination of outgoing traffic is transmitted.

Preferably, communications between devices on the network are conducted with signals encoded according to a codec and the devices support a plurality of codecs. When the first device transmits the suspend signal, step b) preferably involves assigning a less compressive codec to one or more of the other devices upon receipt of the suspend signal.

The less compressive codec can be given to just one other device on the network, or two or more (or all) of the other devices can receive a codec upgrade when the first device goes silent.

The method, in a preferred embodiment, further involves the steps of:

c) receiving from the first device a resume signal indicative that outgoing traffic from that device has been resumed; and

d) upon receipt of the signal, allocating reduced bandwidth to one or more other of the devices.

This illustrates a complementary aspect of the invention, i.e. while increased bandwidth can be assigned to other devices when a first device suspends traffic, the bandwidth for these other devices can also be reduced when the first device resumes traffic. In practice, dynamic bandwidth allocation will generally be implemented, with bandwidth being optimised constantly as each device indicates to other devices on the network that it has stopped or restarted transmitting traffic.

If a VAD system is employed, the first device can resume outgoing traffic when the audio volume of signals for transmission rise above a threshold and transmit the resume signal at that time.

Preferably, communications between devices on the network are conducted with signals encoded according to a codec and devices preferably support a plurality of codecs. In such cases, step b) can be achieved by assigning a more compressive codec upon receipt of the resume signal to the devices which had increased their bandwidth.

In a preferred embodiment, the network is a data packet network and communications over the network are packetised, and the suspend signal takes the form of a distinctive packet transmitted by the first device.

In one embodiment, steps a) and b) are carried out by a second device with which the first device is engaged in a call and step b) comprises allocating additional bandwidth to the second device.

The method can involve the further step of allocating additional bandwidth to the first device for the receipt of traffic when additional bandwidth is allocated to the second device. Thus, the first device can share an improved codec with the second device, during periods when the first device is silent.

If communications between the first and second devices are conducted with signals encoded according to a codec and the first and second devices support a plurality of codecs, step b) can involve the second device switching to a less compressive codec upon receipt of the suspend signal.

Preferably, the second device is provided with a signal processor which incorporates a plurality of different codec sub-processors and the codec switching is effected by switching signal encoding functions from one of the sub-processors to another of the sub-processors.

In another embodiment, steps a) and b) are carried out by a network management device which receives the suspend signal from the first device and dynamically allocates bandwidth to the one or more other devices on receipt of the suspend signal.

Preferably, the network management device allocates bandwidth to devices by specifying to the devices a codec for use in communications over the network, and step b) comprises specifying to the one or more other of the devices a less compressive codec than that being used before the suspend signal issues.

The invention also provides a telecommunications device for use in communications over a network, the device having a plurality of signal processors each for encoding signals using a different codec, and a processor selection mechanism for selecting a processor for use in a call, the processor selection mechanism being responsive to a suspend signal received over the network to select a processor employing a less compressive codec when a call is in progress.

The invention further provides a network management device for assigning bandwidth to a plurality of devices on a communications network, the network management device comprising a signalling unit for signalling to said devices the bandwidth available for use by said devices, a processor for determining bandwidth allocations based on the resources available to the network at a given time, and a signal recognition unit in communication with said processor for receiving and recognising a suspend signal received from a device on the network indicating that the device has suspended outgoing traffic while remaining engaged in a call, said processor being responsive to said signal to allocate increased bandwidth to one or more other of said devices.

In a further aspect, the invention provides a computer program product comprising instructions which, when executed in a network device connected to a network to which a plurality of telecommunications devices are connected, are effective to cause said network device to:

a) monitor a communications channel for a suspend signal from one of the telecommunications devices which is engaged in a call, this suspend signal indicating that outgoing traffic from that device has been temporarily suspended, even though the device remains engaged in the call; and

b) on receiving this suspend signal, to allocate additional bandwidth to one or more other of the devices on the network.

The network device in which this program operates may be one of the telecommunications devices (e.g. a handset) or it may be a network management device as described previously.

In another aspect the invention provides a telecommunications network for enabling communication between a plurality of devices, said network comprising a device having a plurality of signal processors each for encoding signals using a different codec, and a processor selection mechanism for selecting a processor for use in a call, the processor selection mechanism being responsive to a suspend signal received over the network to select a processor employing a less compressive codec when a call is in progress.

The invention further provides an electrical signal in the form of a data packet, said data packet including an indication that the device from which it was emitted has suspended outgoing traffic while remaining engaged in a call.

### BRIEF DESCRIPTION OF THE DRAWINGS

FIG. 1 is a network diagram illustrating a known system architecture in which the present invention may be implemented;

FIG. 2 is a block diagram of a codec switching arrangement for use in a network device according to the present invention;

FIG. 3 is a graph showing the time variation of the voice traffic transmitted by a first device engaged in a call to a second device;

FIG. 4 is a graph showing the time variation of the voice traffic transmitted by the second device engaged in the same call;

FIG. 5 shows an overlay of the voice traffic transmitted by the first and second devices;

FIG. 6 is an illustration of the codecs used over time in a method according to the invention as a result of the traffic transmitted by the first and second devices;

FIG. 7 is a flowchart showing a first sub-procedure carried out by a computer program product according to the invention;

FIG. 8 is a flowchart showing a second sub-procedure carried out by a computer program product according to the invention;

FIG. 9 is a flowchart showing a third sub-procedure carried out by a computer program product according to the invention;

FIG. 10 is a flowchart showing a fourth sub-procedure carried out by a computer program product according to the invention;

### DETAILED DESCRIPTION OF BEST MODE(S)

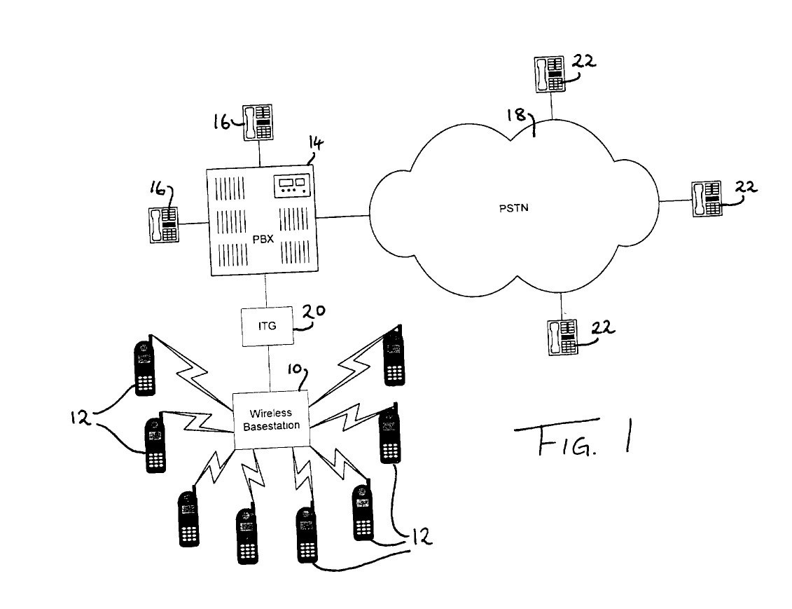

FIG. 1 shows a telecommunications system of a generally known type in which the present invention can be implemented by providing handsets with the ability to dynamically switch codecs when one or more remote handsets is not transmitting while engaged in a call. In the FIG. 1 architecture, in which a wireless network comprising a basestation 10 and a set of eight handsets 12 are in wireless communication in hub-and-spoke arrangement with the basestation relaying signals to and from the handsets, whether individual handsets 12 are communicating with one another, with extensions 16 of the PBX 14, or with telephones 22 connected to the PSTN 18.

Each of the handsets 12 incorporates an IP stack to packetise data (in this case the data being digitised and encoded voice signals) and to transmit the packets to the basestation using the 802.11 protocol. The IP stacks also receive packets and regenerate the encoded signals for subsequent decoding and decompression.

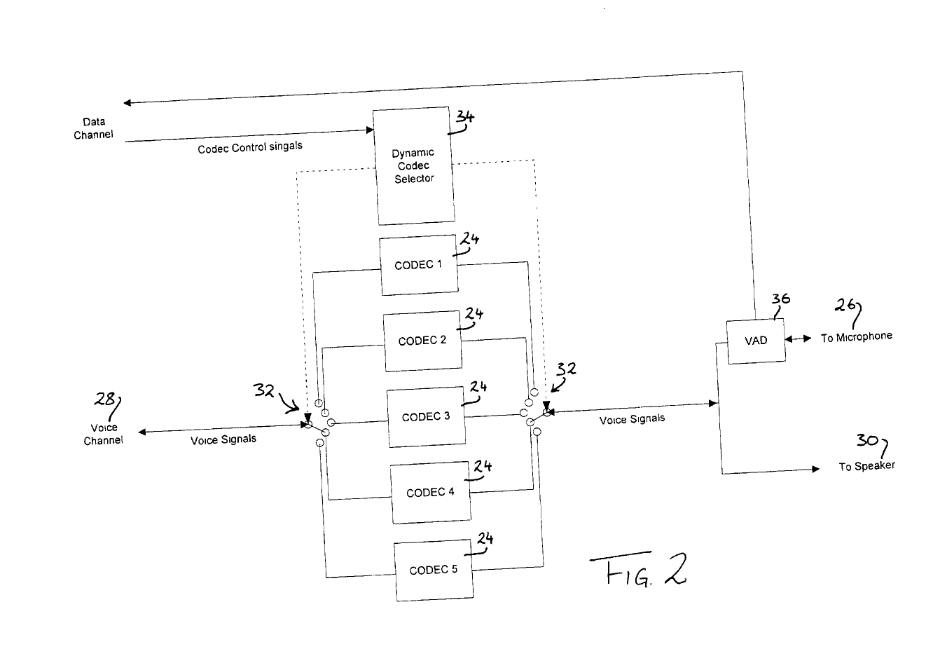

The higher functions of the stack, i.e. encoding/decoding and compression/decompression, are implemented in a digital signal processor (DSP). This processor includes a bank of sub-processors 24. Each sub-processor 24 is designed to implement the functions of a particular codec (indicated in FIG. 2 as Codec 1, Codec 2, etc.). An example of a DSP providing multiple codec support is the Texas Instruments 5421 device. The voice signals are encoded between the microphone 26 and the outgoing voice channel 28 by a particular one of the codecs (shown here as codec 4). Because the same codec is used for received signals as for transmitted signals, the same codec is used for decoding signals arriving over the voice channel before being sent to the speaker 30. The codec selection is effected by a pair of gated switches 32 under the control of a dynamic codec selector 34.

In the case illustrated in FIG. 2, the codec selector operates to implement external instructions received over a data channel which inform the device which codec should be employed. In this scenario, when a call set-up is being negotiated, the gatekeeper of the network (in this case the ITG card 20) determines from the number of devices active at the time which codec should be used, calculating the impact this will have on the available bandwidth. The codec will be selected having regard to the bandwidth free on the network, the priority assigned to each device (e.g. the chief executive's telephone might always be assigned a high quality codec), and the number of other devices which might be expected to become active during the call (i.e. leaving enough bandwidth for other calls to be made).

During a call, however, the network bandwidth allocation device (in the ITG card 20) can instruct the devices to move to a higher quality (more bandwidth, less signal loss) or lower quality (less bandwidth, more signal loss) codec in accordance with the invention by issuing codec control signals to the dynamic codec selector 34, which operates switches 32 to select a different codec sub-processor 24.

The decision to authorise a different codec is made, in accordance with the invention. Each of the devices includes a voice activity detection unit or VAD unit 36 connected to the audio input, which compares the microphone signal with a threshold and cuts the input off if the signal is below the threshold. Because the network is packet based, this results in an immediate cut-off in transmitted packets, and while the device remains engaged in a call, it is effectively in receive only (RX only) mode.

When the microphone input rises above the threshold, i.e. when the user starts to speak again, this is detected by the VAD unit 36 and the signals are passed to the selected codec subprocessor for transmission, with the device reverting to combined transmit/receive (TX/RX) mode. Such VAD units are known in the art.

The invention uses a special suspend signal which issues from the VAD unit 36 and is broadcast in an identifiable packet across the data channel of the network as an indicator that the outgoing traffic from the device has been temporarily suspended, and a corresponding resume signal, again transmitted as a special packet across the network, as an indicator that outgoing traffic is resuming, when the inputs drop below and rise above the threshold respectively.

When the network bandwidth allocation device receives a suspend packet from the device, it realises that the bandwidth available to the network has increased (since no outgoing traffic will occur from the device in question until a resume packet is received), and accordingly can dynamically allocate additional bandwidth to one or more devices on the network by issuing a codec control signal to the one or more other devices and thereby increase their signal quality.

When a large number of devices are on the network, involved in voice conversations, about half of the devices at any one time will be silent, and the bandwidth allocation unit can therefore upgrade many of the devices to higher codecs than would theoretically be allowed according to the network design specifications, which might be based on the worst case scenario that all of the devices are in TX/RX mode. Since each supported codec has a dedicated logic circuit in each device, codecs can be dynamically switched for any device (or pair of devices if two network devices are in a call to one another) without appreciable delays.

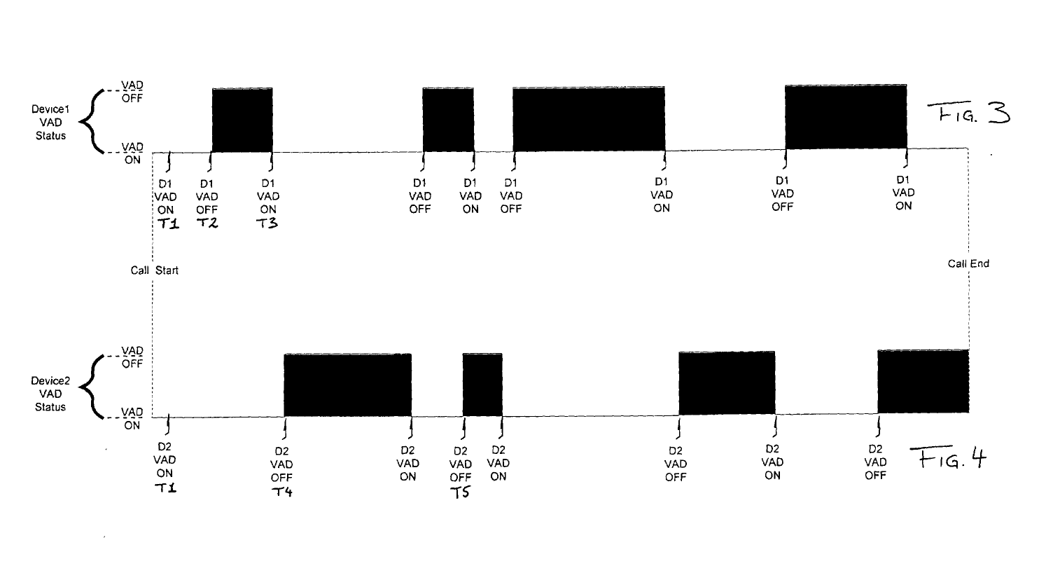

In an alternative scenario, a pair of network devices can themselves dynamically control their codec switches in synchronous manner, as will be explained now with reference to FIGS. 3-6. FIG. 3 shows the microphone input levels varying with time for a first device (Device 1 or D1) and FIG. 4 shows the input levels for a second device (Device 2 or D2). Rather than showing absolute levels, the microphone levels for each device are shown either as a high level (VAD OFF, i.e. the VAD-imposed signal cut-off is deactivated as the input level is above threshold and signals are passed to the codec bank for encoding and transmission) or a low level (VAD ON, i.e. the VAD-imposed signal cut-off is activated as the input level is below threshold, and signals are not passed to the codec bank).

In this two-way voice conversation, there is a short pause before either party speaks, and thus almost immediately after call set-up the VAD unit in each device detects that the input is below threshold and issues to the other device at time T1 a VAD ON packet (a suspend signal). At time T2, the user of device D1 begins to speak, deactivating the VAD-imposed silence. D1 sends a VAD OFF packet to D2. When the user stops speaking at time T3, the VAD again cuts off transmission and sends a VAD ON signal to D2. Shortly thereafter at time T4, the user of device D2 begins to speak and D2 thus sends a VAD OFF signal to D1 as device D2 goes from RX only mode to TX/RX mode.

The conversation proceeds in this way with the users speaking generally alternately. However, at certain times, such as time T5, the VAD OFF signal will issue from one device (D2) before the other device has entered RX only mode. This can be due to an increase in background noise levels or because the user of D2 interrupts the user of D1 speaking.

Referring to FIG. 5, the patterns of activity from the two devices are superimposed, and it can be seen that between times T5 and T6 and between times T7 and T8, the two devices are transmitting. At all other times, either both devices are in the VAD ON state, or only one device is in the VAD OFF state.

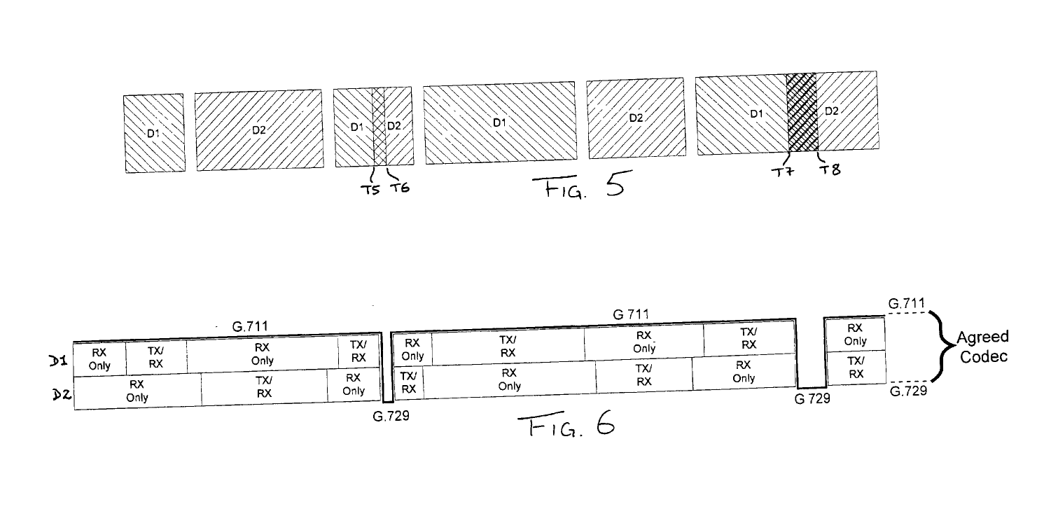

In this arrangement between the two devices, two codecs are available for use, a more compressive codec (G.729), and a higher quality, less compressive codec (G.711). Network specifications state that both devices cannot be transmitting using the G.711 codec at the same time, as this will result in too much bandwidth being consumed by this call. Each device therefore monitors both its own VAD state and the flow of VAD ON and VAD OFF signals arriving from the other device to determine whether G.711 can be used. Between times T5 and T6 and between times T7 and T8, the two devices revert to the G.729 codec, but use the G.711 codec when allowable, i.e. at all other times. FIG. 6 shows how over time the G.711 codec is employed when one or both devices are in RX only mode.

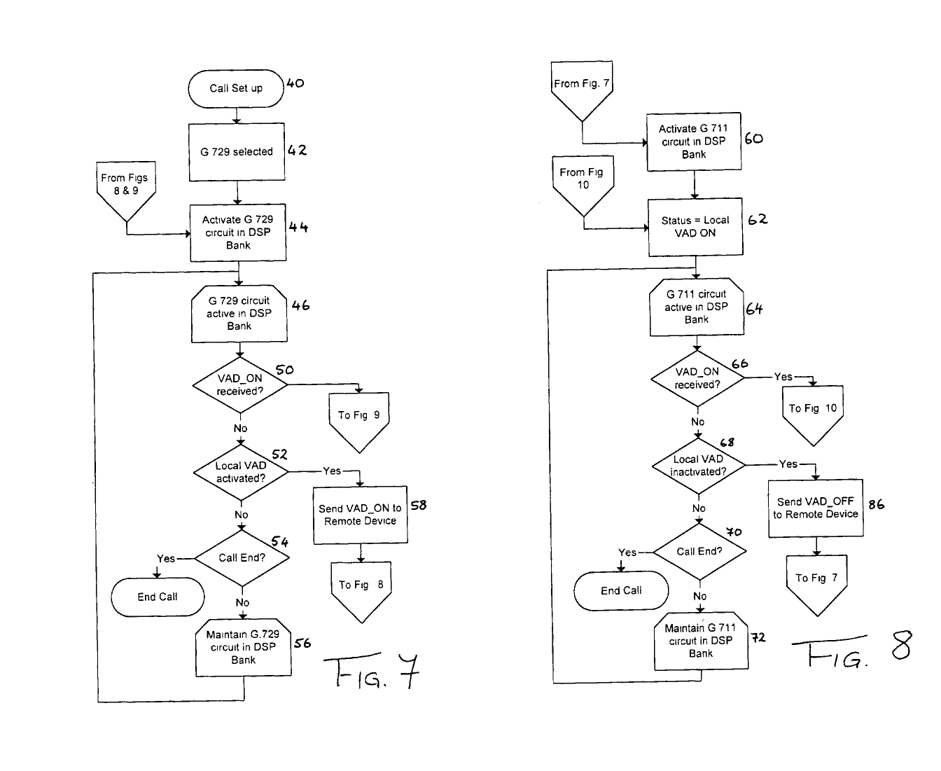

The logic followed by each device's dynamic codec controller 34 (FIG. 2) is controlled by program instructions implemented in software or hardware in the codec controller. In this scenario, no external codec control instructions are received, but instead, only VAD ON or VAD OFF signals from the other device and from the VAD unit of the device itself. The operation of the program is as shown in FIGS. 7-10.

Starting in FIG. 7, call set-up occurs at the beginning of the call, step 40, with the devices negotiating with one another for supported codecs, or if a gatekeeper conducts the call set-up, negotiating via the gatekeeper, which might impose the rule, based on present network conditions that G.729 must be used if both devices are transmitting but G.711 is otherwise allowable. Both devices include in their codec circuit banks, a codec circuit for both G.729 and G.711.

At the beginning of the call (before time T1) both devices are in TX/RX mode and thus G.729 is selected to begin, step 42. The codec controller 34 activates the G.729 circuit, step 44, and the call continues. The codec controller 34 then enters a loop. First it notes that the G.729 circuit is active, step 46, and checks in turn whether a VAD ON packet has been received, step 50, and whether the devices own VAD unit has activated VAD ON status, step 52. The codec controller also checks that the call is still in progress, step 54. If none of these conditions occurs, the conditions dictating that G.729 is the appropriate circuit still pertain and thus the G.729 circuit is maintained active, step 56, before the process loops back to step 46.

When the device's own VAD unit detects a microphone level below threshold, and activates the signal cut-off, this is noted in step 52. The device sends a VAD ON packet to the remote device, step 58 and the process proceeds to FIG. 8.

The G.711 circuit is activated, step 60, since the device itself is no longer transmitting, and a status flag within the device indicates that locally, the VAD ON state is in force, step 62 (but that the remote VAD is not on). A loop is then entered in step 64, with the codec controller noting that G.711 is in use. A check is made for a received VAD ON packet from the remote device (as would occur if the other user also fell silent), step 66, and then a check is made to see if the local VAD has been inactivated, step 68, before checking if the call has ended, step 70. Again if none of these conditions is fulfilled, the G.711 circuit is maintained, step 72, and the process revert to step 64. Referring to FIG. 3, device D1 would be in this loop immediately after time T1, when its own VAD circuit was activated, and before it receives the VAD ON packet from device D2 which will arrive a finite time later.

When a device in the loop of FIG. 8 receives a VAD ON packet from the other device, step 66 (so that now both devices are in RX only mode), the process proceeds to FIG. 10. This occurs for both device D1 and D2 shortly after time T1, when each device receives the other's VAD ON packet after having locally entered the VAD ON state.

In FIG. 10, the flag is updated to reflect the fact that VAD ON pertains in both devices, step 74. A loop is then entered in step 76, with the codec controller noting that G.711 is still in use. Checks are made for the remote device beginning to transmit traffic, i.e. for receipt of a VAD OFF signal, step 78, and for the device itself entering the VAD OFF state as it begins to resume transmitting (if the local user begins to speak), step 80. If neither condition occurs, and the call has not ended, step 82, the G.711 circuit is maintained active, step 84, and the process reverts to step 76.

If in step 78 of FIG. 10, the device receives a VAD OFF signal from the remote device, then the process reverts to FIG. 8, step 62. No change is made to the active codec (since the local VAD is still on, and only the remote device is transmitting), but the flag is updated.

To complete the description of FIG. 8 (which can be the active process as a result of local VAD activation in step 52 of FIG. 7 or remote VAD inactivation in step 78 of FIG. 10), there is the possibility that the local VAD is deactivated when the remote VAD is already off. This occurs for device D2 at time T5 and is detected in FIG. 8 at step 68. A VAD OFF signal is sent to the remote device and the process reverts to step 44 of FIG. 7, with the G.729 circuit being activated because both devices are again transmitting.

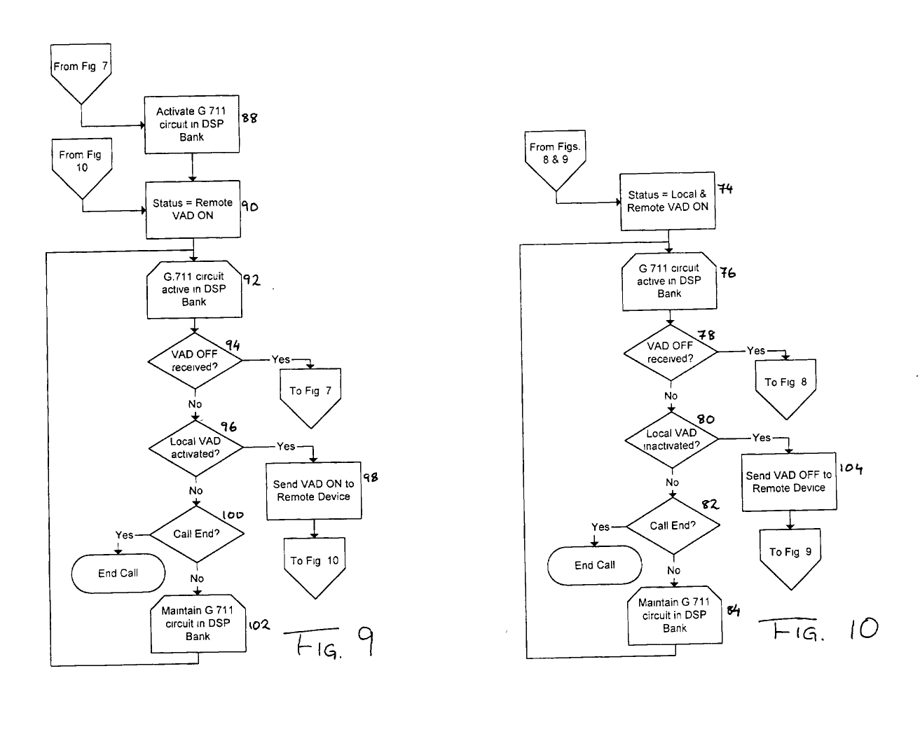

At time T6, FIG. 5, device D1 stops transmitting when device D2 is still transmitting before this occurs, both devices are in the FIG. 7 loop. For device D1, the process notes local VAD activation at step 52, and the process moves to FIG. 8, as previously described. Device D2, however, receives the VAD ON packet from D1 and the process therefore branches off at step 50 to FIG. 9.

In this scenario of FIG. 9, the G.711 circuit is activated, step 88, and the flag is set to note that the remote device is silent although locally, transmissions of traffic continue, step 90. A loop is entered, step 92, and checks are made in steps 94 and 96 for changes in the state of the remote device (is a VAD OFF received?) and the local device (is the local VAD activated?). If the remote device begins to transmit (VAD OFF received, step 94) then the process moves to FIG. 7, step 44, as previously described, where both devices are transmitting. If the device itself stops transmitting, step 96, then a VAD ON signal is sent to the other device, step 98, and the process moves to FIG. 10, step 74.

If neither condition occurs, a check is made to see if the call has ended, step 100, and the G.711 circuit is maintained active, step 102, before looping back to step 92.

The final transition to be described is in FIG. 10, where both devices are in the silent state (VAD ON). If at step 80, the local VAD is inactivated, a VAD OFF signal is transmitted, step 104, and the process moves to step 90 of FIG. 9.

In this way the four states resulting from the permutations of the local device having voice traffic active or inactive and the remote device having voice traffic active or inactive are accounted for by the sub-processes of FIGS. 7, 8, 9, and 10, and the process switches between these sub-processes in a computer implemented method of the invention, carried out by a suitably programmed processor or a hard wired logic circuit incorporated in a telecommunications device according to the invention.

The invention is not limited to the embodiments disclosed herein which may be departed from or varied within the scope of the claimed invention.

What is claimed is:

1. A method of allocating bandwidth resources in a telecommunications network to which a plurality of devices are connected, said method comprising:
a) receiving from a first of said devices engaged in a call a suspend signal indicative that outgoing traffic from that device has been temporarily suspended, while the device remains engaged in said call; and
b) upon receipt of said signal, allocating additional bandwidth to one or more other of said devices.

2. A method as claimed in claim 1, wherein the first device employs an audio volume threshold detection system to suspend outgoing traffic when the audio volume of signals for transmission drop below a threshold and said first device transmits said suspend signal when outgoing traffic is suspended.

3. A method as claimed in claim 1, wherein communications between devices on the network are conducted with signals encoded according to a codec and said one or more other of said devices support a plurality of codecs, and wherein step b) comprises assigning a less compressive codec to said one or more other of said devices upon receipt of said suspend signal.

4. A method as claimed in claim 1, further comprising the steps of:
c) receiving from said first device a resume signal indicative that outgoing traffic from that device has been resumed; and
b) upon receipt of said signal, allocating reduced bandwidth to one or more other of said devices.

5. A method as claimed in claim 4, wherein the first device employs an audio volume threshold detection system to resume outgoing traffic when the audio volume of signals for transmission rise above a threshold and said first device transmits said resume signal when outgoing traffic is resumed.

6. A method as claimed in claim 4, wherein communications between devices on the network are conducted with signals encoded according to a codec and said one or more other of said devices support a plurality of codecs, and wherein step b) comprises assigning a more compressive codec to said one or more other of said devices upon receipt of said resume signal.

7. A method as claimed in claim 1, wherein said network is a data packet network and communications over said network are packetised, and wherein said suspend signal takes the form of a distinctive packet transmitted by the first device.

8. A method as claimed in claim 1, wherein steps a) and b) are carried out by a second device with which said first device is engaged in a call and wherein step b) comprises allocating additional bandwidth to said second device.

9. A method as claimed in claim 8, further comprising the step of allocating additional bandwidth to said first device for the receipt of traffic when additional bandwidth is allocated to said second device.

10. A method as claimed in claim 8, wherein communications between said first and second devices are conducted with signals encoded according to a codec and said first and second devices support a plurality of codecs, and wherein step b) comprises the second device switching to a less compressive codec upon receipt of said suspend signal.

11. A method as claimed in claim 10, wherein said second device is provided with a signal processor which incorporates a plurality of different codec sub-processors and said codec switching is effected by switching signal encoding functions from one of said sub-processors to another of said sub-processors.

12. A method as claimed in claim 1, wherein steps a) and b) are carried out by a network management device which receives said suspend signal from the first device and dynamically allocates bandwidth to said one or more other devices on receipt of said suspend signal.

13. A method as claimed in claim 12, wherein said network management device allocates bandwidth to devices by specifying to said devices a codec for use in communications over the network, and step b) comprises specifying to said one or more other of said devices a less compressive codec than that being used before said suspend signal issues.

14. A telecommunications device for use in communications over a network, said device comprising a plurality of signal processors each for encoding signals using a different codec, and a processor selection mechanism for selecting a processor for use in a call, said processor selection mechanism being responsive to a suspend signal received over the network to select a processor employing a less compressive codec when a call is in progress.

15. A network management device for assigning bandwidth to a plurality of devices on a communications network, the network management device comprising a signalling unit for signalling to said devices the bandwidth available for use by said devices, a processor for determining bandwidth allocations based on the resources available to the network at a given time, and a signal recognition unit in communication with said processor for receiving and recognising a suspend signal received from a device on the network indicating that the device has suspended outgoing traffic while remaining engaged in a call, said processor being responsive to said signal to allocate increased bandwidth to one or more other of said devices.

16. A network management device as claimed in claim 15, wherein said signalling unit operates by signalling to said devices a codec identifier identifying a codec for use by the devices, and said processor determines bandwidth allocations by assigning particular codecs to the devices.

17. A network management device as claimed in claim 16, wherein said signalling unit is adapted to signal different codecs to different devices.

18. A computer program product comprising instructions which, when executed in a network device connected to a network to which a plurality of telecommunications devices are connected, are effective to cause said network device to:
a) monitor a communications channel for a suspend signal from one of the telecommunications devices which is engaged in a call, this suspend signal indicating that outgoing traffic from that device has been temporarily suspended, even though the device remains engaged in the call; and
b) on receiving this suspend signal, to allocate additional bandwidth to one or more other of the devices on the network.

19. A computer program product as claimed in claim 18, wherein said network device in which the instructions are executed is a telecommunications devices engaged in a call.

20. A computer program product as claimed in claim 18, wherein said network device in which the instructions are executed is a network management device for allocating network resources to devices connected to the network.

21. A telecommunications network for enabling communication between a plurality of devices, said network comprising a device having a plurality of signal processors each for encoding signals using a different codec, and a processor selection mechanism for selecting a processor for use in a call, the processor selection mechanism being responsive to a suspend signal received over the network to select a processor employing a less compressive codec when a call is in progress.

22. An electrical signal in the form of a data packet, said data packet including an indication that the device from which it was emitted has suspended outgoing traffic while remaining engaged in a call.
